(19) United States
(12) Patent Application Publication
(10) Pub. No.: US 2013/0294872 A1
(43) Pub. Date: Nov. 7, 2013

(54) LIBRARY APPARATUS

(71) Applicant: FUJITSU LIMITED, Kawasaki-shi (JP)

(72) Inventor: Daisuke HORI, Yokohama (JP)

(73) Assignee: FUJITSU LIMITED, Kawasaki-shi (JP)

(21) Appl. No.: 13/774,180

(22) Filed: Feb. 22, 2013

(30) Foreign Application Priority Data
May 7, 2012 (JP) 2012-106086

(51) Int. Cl. B65G 1/12

(52) U.S. Cl. CPC B65G 1/12
USPC 414/280

(57) ABSTRACT

A library apparatus includes: a storage rack configured to be capable of storing a plurality of recording media; a recording-and-reproducing device configured to perform a recording operation and a reproducing operation on the recording media; a robot configured to deliver the recording media between the storage rack and the recording-and-reproducing device using a hand mechanism; an elevator platform configured to carry the hand mechanism; a pair of toothed belts, provided between a driving pulley and a driven pulley, configured to move the elevator platform vertically; a pair of belt-connecting portions configured to couple one of ends of the elevator platform to one of the pair of toothed belts respectively; and a disconnecting mechanism configured to release at least one of connections at the pair of belt connecting portions.

### CROSS-REFERENCE TO RELATED APPLICATIONS

This application is based upon and claims the benefit of priority of the prior Japanese Patent Application No. 2012-106086 filed on May 7, 2012, the entire contents of which are incorporated herein by reference.

### FIELD

The embodiments discussed herein are related to a library apparatus.

### BACKGROUND

A library apparatus, which serves as an external mass storage device, stores several hundreds of magnetic tapes or optical disks, which serve as recording media, in a housing called a “locker” and performs automatic writing and reading of recording data. In the locker of a library apparatus, a recording-and-reproducing device that writes data into and reads data from the recording media, a loading-and-ejecting device that loads and ejects the recording media, a storage rack on which the recording media are stored, and a transport device that transports the recording media. The recording-and-reproducing device may be called a “drive”, the loading-and-ejecting device may be called a “CAS”, the storage rack may be called a “slot”, and the media transport device may be called a “robot”. The robot transports the recording media from the slot to the drive or to the CAS.

Related art is disclosed in Japanese Laid-open Patent Publication No 2011-42463.

### SUMMARY

According to one aspect of the embodiments, a library apparatus includes: a storage rack configured to be capable of storing a plurality of recording media; a recording-and-reproducing device configured to perform a recording operation and a reproducing operation on the recording media; a robot configured to deliver the recording media between the storage rack and the recording-and-reproducing device using a hand mechanism; an elevator platform configured to carry the hand mechanism; a pair of toothed belts, provided between a driving pulley and a driven pulley, configured to move the elevator platform vertically; a pair of belt-connecting portions configured to couple one of ends of the elevator platform to one of the pair of toothed belts respectively; and a disconnecting mechanism configured to release at least one of connections at the pair of belt connecting portions.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is an exemplary perspective view of a library apparatus;

FIG. 1B is an exemplary perspective view of a robot and an elevator mechanism;

FIG. 1C illustrates an exemplary state in which a recording medium has been transported to a drive;

FIG. 2A illustrates an exemplary elevator mechanism;

FIG. 2B illustrates an exemplary example of belt-connecting portion;

FIG. 3A illustrates an exemplary belt-connecting portions;

FIG. 3B illustrates an exemplary elevator mechanism;

FIGS. 3C and 3D illustrate an exemplary timing belt and an exemplary base member;

FIGS. 4A and 4B illustrate an exemplary belt-connecting portion;

FIGS. 5A and 5B illustrate an exemplary disconnecting mechanism;

FIGS. 6A and 6B illustrate an exemplary belt-connecting portion;

FIG. 7 illustrates an exemplary recovery processing;

FIG. 8 illustrates an exemplary recovery processing;

FIGS. 9A to 9J illustrate an exemplary inclination-correcting process;

FIG. 10 illustrates an exemplary disconnecting mechanism;

FIGS. 11A and 11B illustrate an exemplary disconnecting mechanism;

FIG. 12 illustrates an exemplary disconnecting mechanism; and

FIGS. 13A to 13F illustrate an exemplary disconnecting mechanism.

### DESCRIPTION OF EMBODIMENTS

In a library apparatus, a robot is moved by two belts that are operably associated with each other. In the library apparatus, when an elevator platform, for example, a base member of the robot, is vertically moved, the ends of the elevator platform are coupled to driving-force transmitting members, such as timing belts (toothed belts), whereby the elevator platform is maintained in a horizontal position by forces simultaneously applied to the ends. Two driving pulleys are coupled to each other via a shaft or the like, so that the two timing belts are simultaneously moved.

In a driving mechanism using the timing belts, a tooth-jumping phenomenon, in which a belt is instantaneously separated from a driving pulley and a tooth of the belt jumps over a tooth of the driving pulley, may occur owing to lowering of the tension of the belts caused by aging or due to a high impact applied during transportation. In a driving mechanism in which two driving pulleys are coupled to each other by a rotation shaft, if a tooth-jumping phenomenon occurs in one belt, the heights of coupling portions, at which the belts and the base member are coupled, may become different from each other, for example, a phase shift between the belts may occur, and hence, the base member may be inclined, causing an erroneous movement of the robot.

When a phase shift between the belts is to be corrected, a maintenance person may work after the library apparatus is stopped. The maintenance person decreases the tension of a belt to reduce the meshing force between the belt and the driving pulley, returns the displaced tooth to the original position, then increases the tension to stretch the belt and align the phase.

For example, in a large-capacity carrying device that moves a horizontal tray carrying sheets up and down, tooth-jumping between timing belts, which move the horizontal tray up and down, and pulleys, which drive the timing belts, is detected and corrected, so that the inclination of the horizontal tray is reduced. Two of four timing belts that move the horizontal tray up and down are driven by pulley-driven belts stretched between the pulleys. When the horizontal tray is inclined, the tension of a pulley-driven belt is reduced, so that tooth-jumping is caused between the pulley-driven belt and the pulley. By causing tooth-jumping to occur between the pulley and the pulley-driven belt that are not the pulley and the pulley-driven belt between which the first tooth-jumping occurs previously, the horizontal tray is returned to a horizontal state, after which the tension of the pulley-driven belt is increased.

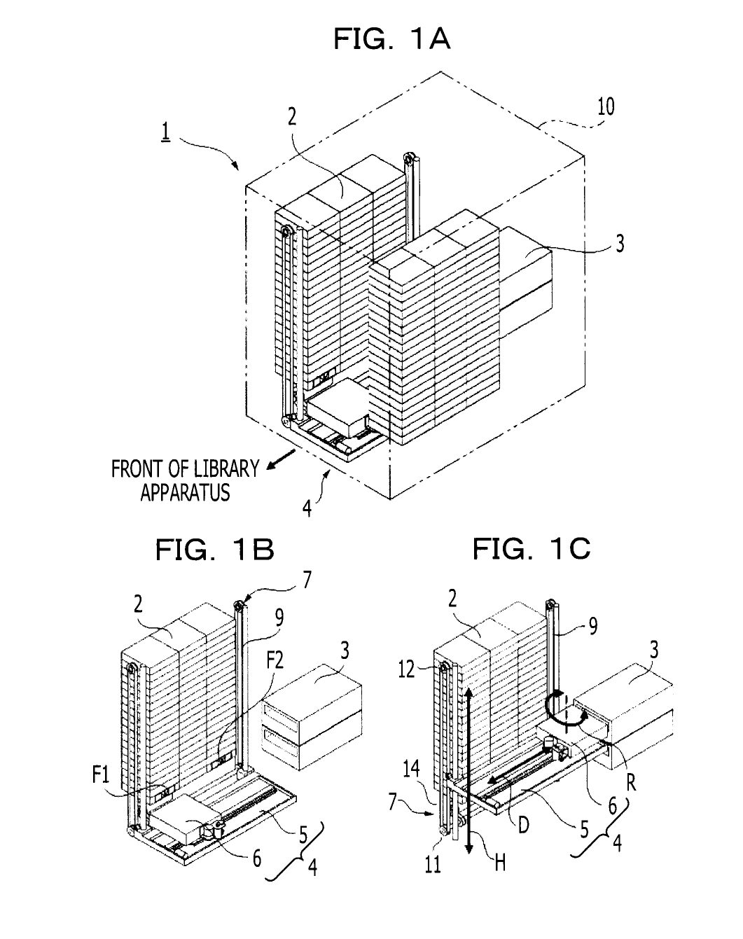

FIG. 1A is an exemplary perspective view of a library apparatus. A locker 10, which is a housing of a library apparatus 1, may include slots 2 that store a plurality of recording media, a drive 3 that records data into and reproduces data from the recording media, and a robot 4 that transports the recording media between the slots 2 and the drive 3. A control unit (not illustrated) may be provided in the locker 10. The slots 2 may be provided above the drive 3.

FIG. 1B is an exemplary perspective view of the robot and an elevator mechanisms. In FIG. 1B, the slot 2 on the near side, for example, on the right side as viewed from the front of the library apparatus, is removed from the library apparatus 1 illustrated in FIG. 1A. FIG. 1C illustrates an exemplary state in which a recording medium has been transported to a drive. In FIG. 1C, the robot 4 illustrated in FIG. 1B may transport the recording medium to the drive 3. For example, a cartridge tape, such as a linear tape-open (LTO) cartridge tape, may be used as the recording medium. The LTO cartridge tape accommodates, inside a casing, a reel hub on which the magnetic tape is wound. The tape is led out with a leader pin provided at an end of the magnetic tape. For example, a known LTO cartridge tape may be used.

The robot 4 includes a base member 5, a hand mechanism 6 that moves the base member 5 in an arrow D direction, for example, a device depth direction, and the elevator mechanisms 7 that move the base member 5 up and down in an arrow H direction, for example, a height direction, along guide posts 9. The elevator mechanisms 7 move the base member 5 up by timing belts 14, which are toothed belts stretched between driving pulleys 11 and driven pulleys 12. Since the hand mechanism 6 is rotatable in arrow R directions, a cartridge tape may be taken out of either of the right and left slots 2 and ma be transported to the cartridge tape to the drive 3. For example, the robot 4 transports the cartridge tape between the slot 2 and the drive 3 and between the slot 2 and the CAS (not illustrated) with straight-line motions along two axes and a rotational motion about one axis. A first flag F1 and a second flag F2 are provided at the lower end portions of the slots 2 of the library apparatus 1. The first flag F1 and the second flag F2 may be read by a camera (not illustrated) mounted on the hand mechanism 6 so as to be used to adjust the levelness of the base member 5 or to correct the reference position of the hand mechanism 6.

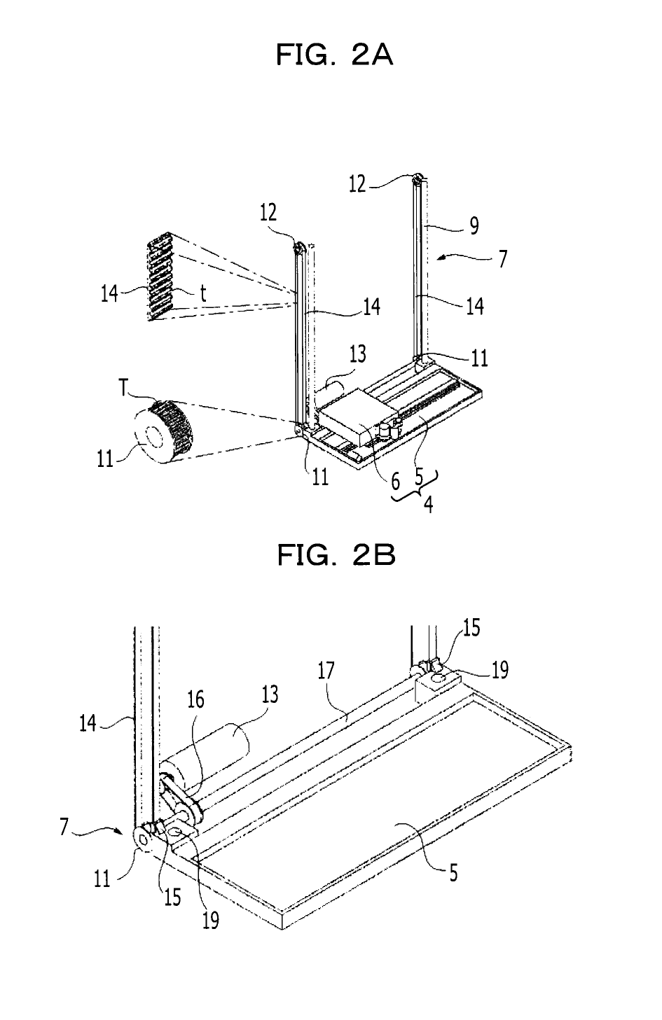

FIG. 2A illustrates an exemplary elevator mechanism 7. FIG. 2A may illustrate the elevator mechanisms 7 of the robot 4 illustrated in FIG. 1B. FIG. 2B illustrates an exemplary belt-connecting portion. FIG. 2B may illustrate a partial enlarged perspective view of belt-connecting portions 15 that couple the base member 5 of the robot 4, illustrated in FIG. 1A, and the timing belts 14 that moves the base member 5 up and down. The driving pulleys 11 have teeth T on the outer circumferential surfaces thereof. The structure of the driven pulleys 12 may be substantially the same as or similar to that of the driving pulleys 11. Teeth t provided on the inner circumferential surfaces of the timing belts 14 mesh with the teeth Ton the driving pulleys 11 and the driven pulleys 12.

The elevator mechanisms 7 are provided on both sides of the base member 5, and the two driving pulleys 11 are coupled to each other by a rotation shaft 17. The rotation shaft 17 that rotates the driving pulleys 11 is rotated by a driving belt 16 stretched between the rotation shaft 17 and a motor 13. FIG. 2B, illustration of the guide posts 9 may be omitted. The guide posts 9 pass through guide holes 19 provided at both ends of the base member 5. In the elevator mechanisms 7, the timing belts 14 and the base member 5 may be coupled by the belt-connecting portions 15.

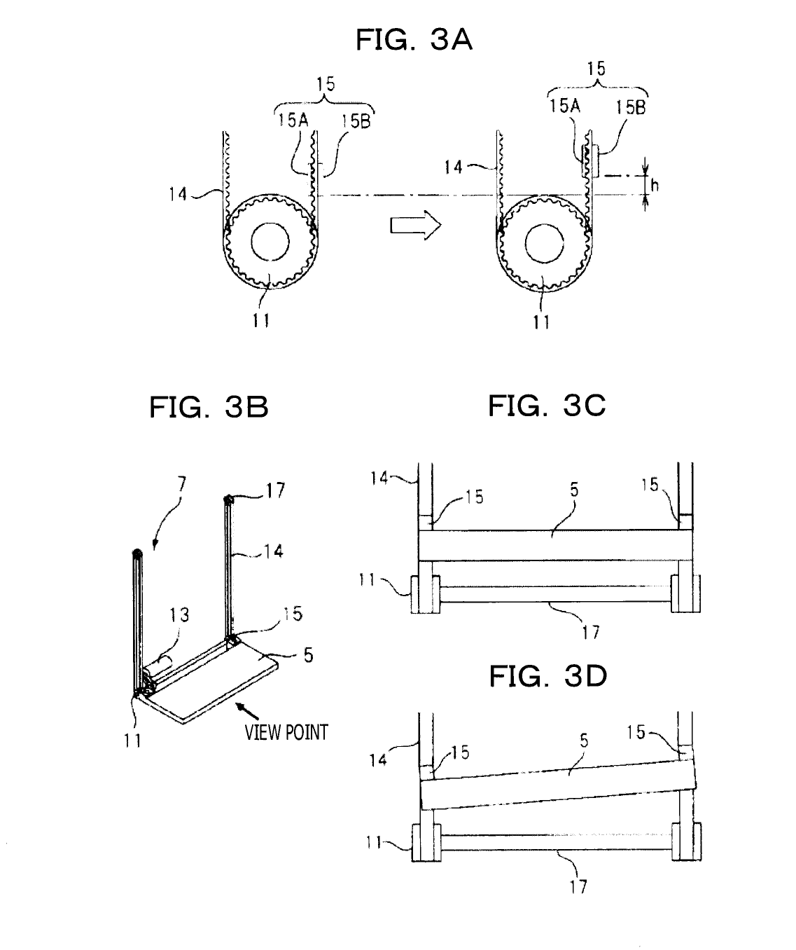

FIG. 3A illustrates an exemplary belt-connecting portion 15. The picture on the left side in FIG. 3A illustrates, in detail, the connecting portion 15 between the timing belt 14 and the base member 5. The belt-connecting portions 15 each include a fixed portion 15B provided integrally with the base member 5, and an engaging piece 15A that is attached to the fixed portion 15B via a screw or the like. By securely attaching the engaging pieces 15A to the fixed portions 15B, the timing belts 14 and the base member 5 are coupled by the belt-connecting portions 15. When the timing belts 14 are vertically moved by the driving pulleys 11, the base member 5 moves vertically. If, for some reason, the driving pulleys 11 do not rotate and only the timing belts 14 move, tooth-jumping may occur, resulting in a situation illustrated on the right side in FIG. 3A. The heights of the positions of the belt-connecting portions 15 may become different from each other by a height h owing to tooth-jumping. The tooth-jumping may be called a phase shift between the timing belts 14.

FIG. 3B illustrates an exemplary elevator mechanism. FIGS. 3C and 3D illustrate an exemplary belt and an exemplary base member. In FIG. 3B, the elevator mechanisms 7 illustrated in FIGS. 1 and 2 may be viewed from view point. For example, when there is no phase shift between the timing belts 14 as illustrated in the picture on the left side in FIG. 3A, as illustrated in FIG. 3C, the base member 5 may be horizontal with respect to the timing belts 14. For example, as illustrated in the picture on the left side in FIG. 3A, when there is a phase shift between the timing belts 14 as illustrated in the picture on the left side in FIG. 3A, as illustrated in FIG. 3D, the base member 5 may be inclined with respect to the timing belts 14. The inclination of the base member 5 due to a phase shift between the timing belts 14 like this may be returned to a horizontal state.

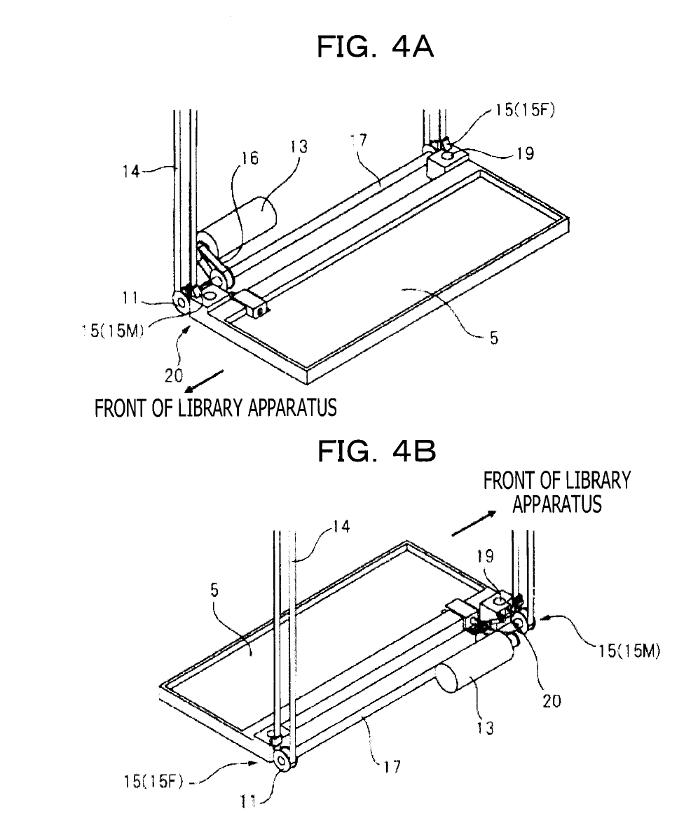

FIGS. 4A and 4B illustrate an exemplary belt-connecting portions. FIG. 4A may be a partial perspective view of the belt-connecting portions 15, as viewed from the front of the library apparatus. FIG. 4B may be a partial perspective view of the belt-connecting portions 15, as viewed from the back of the library apparatus. A disconnecting mechanism 20 may be provided on one of the belt-connecting portions 15 coupling the timing belts 14 and the base member 5. The belt-connecting portion 15 with the disconnecting mechanism 20 may be called a “movable belt-connecting portion 15M”, and the belt-connecting portion 15 without the disconnecting mechanism 20 may be called a “fixed belt-connecting portion 15F”.

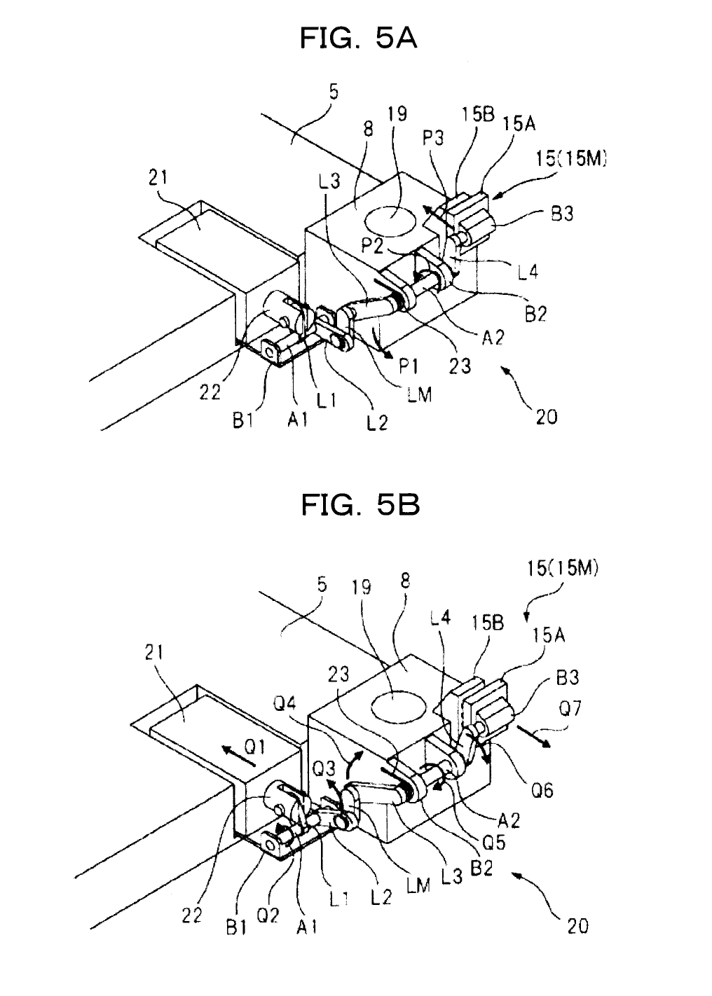

FIGS. 5A and 5B illustrate an exemplary disconnecting mechanism. FIG. 5A may illustrate a state in which the movable belt-connecting portion 15M, illustrated in FIG. 4B, is coupled to the timing belt. FIG. 5B may illustrate a state in which the movable belt-connecting portion 15M, illustrated in FIG. 5A, is disconnected from the timing belt.

As illustrated in FIG. 5A, a solenoid 21 with a plunger 22 is provided near the movable belt-connecting portion 15M of the base member 5. When the solenoid 21 is deenergized, the plunger 22 protrudes from the solenoid 21, and when the solenoid 21 is energized, the plunger 22 is retracted into the solenoid 21. A bracket B1 is attached to the base member 5 at a position immediately below the plunger 22. A rotation shaft A1 is supported by the bracket B1 in a rotatable manner. Base portions of a lever L1 and a lever L2 are fixed to the rotation shaft A1. A distal end of the lever L1 is coupled to a distal end of the plunger 22 in a rotatable manner.

The movable belt-connecting portion 15M is provided at an end of a guide block 8 having the guide hole 19, through which the guide post 9 passes. A bracket B2 is provided on the guide block 8, at a position adjacent to the movable belt-connecting portion 15M. A rotation shaft A2 is supported by the bracket B2 in a rotatable manner. The rotation shaft A2 is provided with a lever L3 at an end near the solenoid 21 and a lever L4 at the other end. A distal end of the lever L2 and the distal end of the lever L3 are coupled to each other by an intermediate link LM. A distal end of the lever L4 is coupled, in a rotatable manner, to a bracket B3 provided on the back surface of the engaging piece 15A of the movable belt-connecting portion 15M.

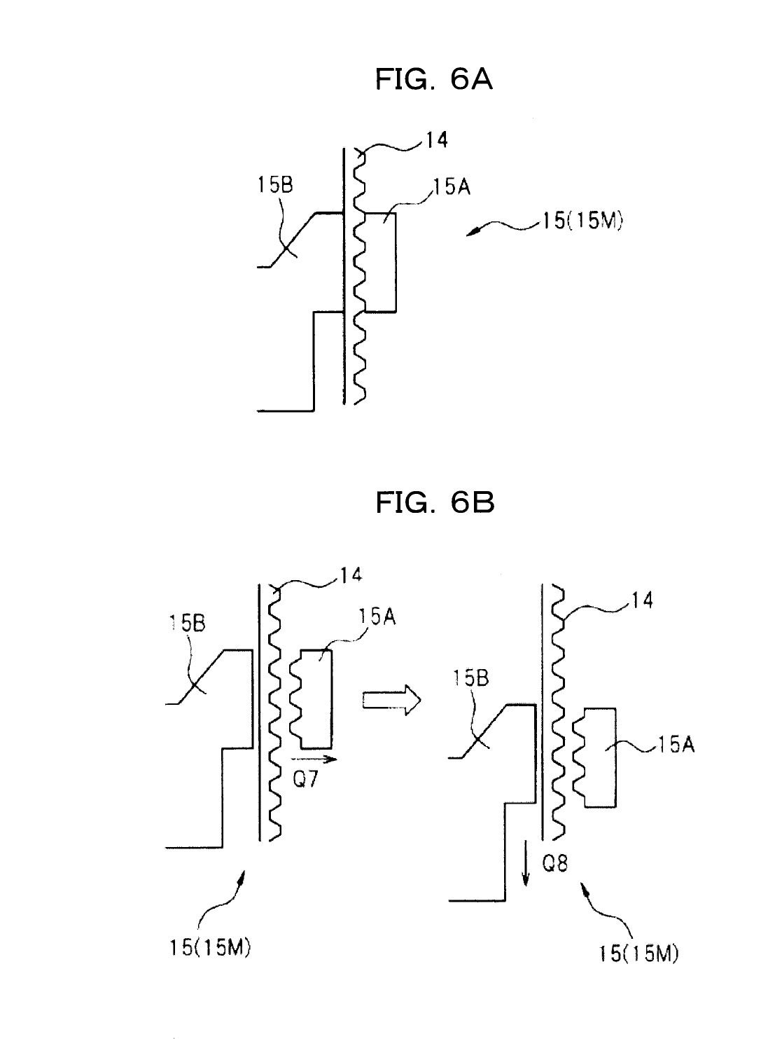

FIGS. 6A and 6B illustrate an exemplary belt-connecting portion. A spring 23 that biases the lever L3 in an arrow P1 direction is provided at a base portion of the lever L3, which is attached to the rotation shaft A2 supported by the bracket B2. When the lever L3 is biased in the arrow P1 direction, a rotational force that causes the rotation shaft A2 to rotate in an arrow P2 direction is applied from the lever L3 to the rotation shaft A2. When the rotation shaft A2 is subjected to an urging force that causes the rotation shaft A2 to rotate in the arrow P2 direction, an urging force in an arrow P3 direction is applied from the lever L4 to the third bracket B3. As illustrated in FIG. 6A, the timing belt 14 is sandwiched and firmly fixed between the engaging piece 15A and the fixed portion 15B of the movable belt-connecting portion 15M owing to the urging force in the arrow P3 direction.

When the timing belt 14 is disconnected from the movable belt-connecting portion 15M, as illustrated in FIG. 5B, the solenoid 21 is energized. The energized solenoid 21 draws the plunger 22 in an arrow Q1 direction. When the plunger 22 moves in the arrow Q1 direction, the rotation shaft A1 is rotated in an arrow Q2 direction via the lever L1. When the rotation shaft A1 is rotated in the arrow Q2 direction, the lever L2 is rotated in an arrow Q3 direction, causing the ever L3 to rotate in an arrow Q4 direction via the intermediate link LM while overcoming the urging force exerted by the spring 23. Because the lever L3 is rotated in the arrow Q4 direction, the rotation shaft A2 is rotated in an arrow Q5 direction, causing the lever L4 to rotate in an arrow Q6 direction.

When the lever L4 is rotated in the arrow Q6 direction, the bracket B3 engaged with the distal end of the lever L4 moves in an arrow Q7 direction. As a result, as illustrated in a picture on the left side in FIG. 6B, the engaging piece 15A of the movable belt-connecting portion 15M, to which the bracket B3 is attached, is moved in the arrow Q7 direction, thus disconnecting the engaging piece 15A from the timing belt 14. For example, when the movable belt-connecting portion 15M is located above the fixed belt-connecting portion 15F, the movable belt-connecting portion 15M falls by gravity in an arrow Q8 direction, as illustrated in a picture on the right side in FIG. 6B. When the base member 5 is inclined, control to disconnect or connect the movable belt-connecting portion 15M may be performed depending on the direction in which the base member 5 is inclined, because the movable belt-connecting portion 15M may not be higher than the fixed belt-connecting portion 15F.

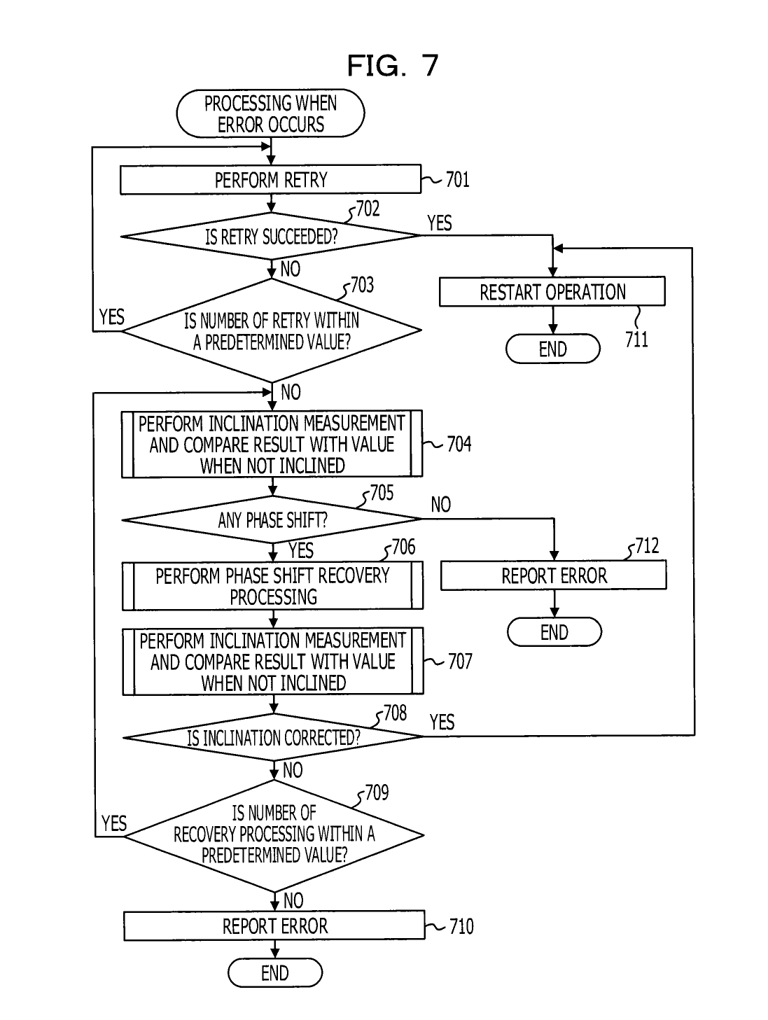

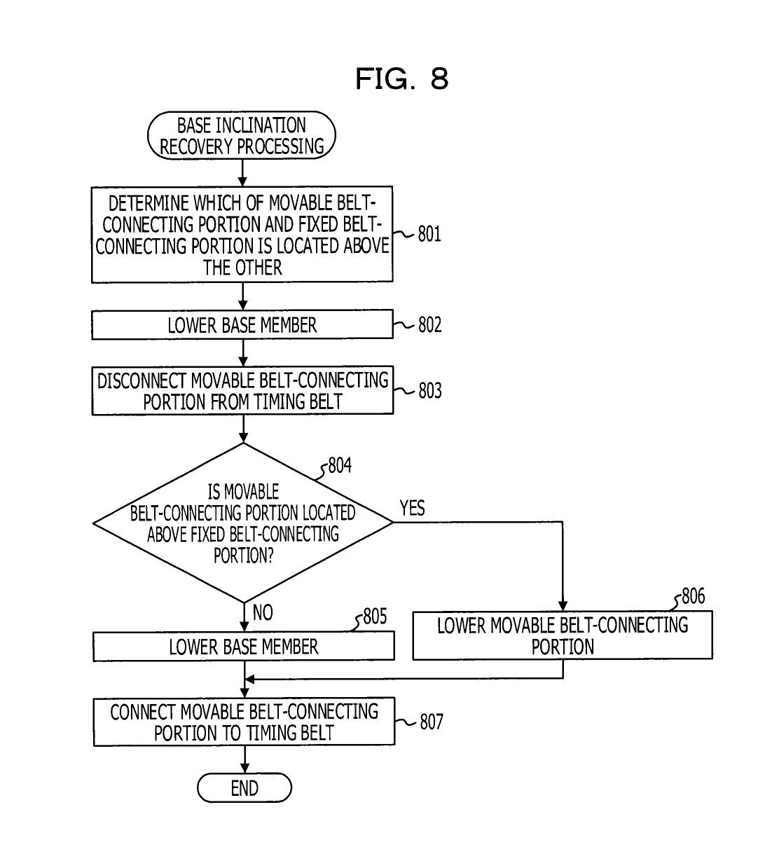

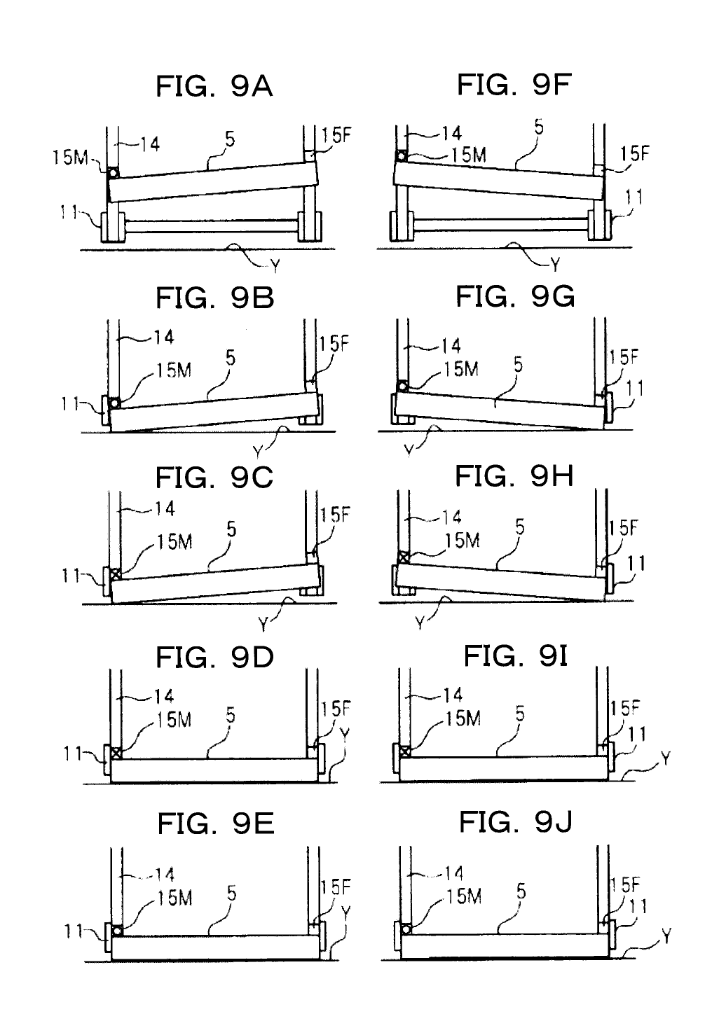

FIGS. 7 and 8 illustrate an exemplary recovery processing. When an error, including an inclination error of the base member 5, occurs in the library apparatus, the control unit may perform the recovery processing illustrated in FIGS. 7 and 8. FIGS. 9A to 9J illustrate an exemplary inclination-correcting process. FIGS. 9A to 9J may illustrate the inclination-correcting process to correct the inclination of the base member 5.

When an error occurs in the library apparatus, an LTO cartridge tape may not be inserted into a slot or a drive. Thus, when an error occurs in the library apparatus, retry is performed to insert the LTO cartridge tape again into the slot or the drive in an operation 701. In an operation 702, it is determined whether or not retry is succeeded. When retry is succeeded (YES), the flow proceeds to an operation 711, where the operation of the library apparatus is restarted, and then the flow ends. When retry fails (NO), the flow proceeds to an operation 703, where it is determined whether or not the number of times retry is performed is within a predetermined value. When the number of times retry is performed is within a predetermined value (YES), a series of the operations from 701 to 703 is repeated. When the number of times retry is performed exceeds the predetermined value (NO), the flow proceeds to an operation 704.

Errors of the library apparatus include improper insertion of the cartridge tape, which may occur when the base member 5 carrying the hand mechanism 6 is inclined. Thus, in the operation 704, the inclination of the base member 5 is measured, and the measured value is compared with the value obtained when the base member 5 is not inclined. Whether or not the base member 5 is inclined may be determined by reading position-correction flags with the robot 4. For example, whether or not the base member 5 is inclined is determined by comparing a previously measured correction flag value with the latest measured value. The position-correction flags may be read by using a known technique. The first flag F1 and the second flag F2 illustrated in FIG. 1B may correspond to the position-correction flags.

In an operation 705, whether or not the base member 5 is inclined is determined based on the measurement in operation 704. When the base member 5 is inclined, because it may be caused by tooth-jumping (phase shift) occurring between the timing belt and the driving pulley, whether or not a phase shift occurs is determined in the operation 705. When it is determined that no phase shift occurs in the operation 705 (NO), the flow proceeds to an operation 712. In the library apparatus, an error other than the error caused by the inclined base member 5 may be serious. Hence, in the operation 712, the error is reported to a management company to request recovery by a maintenance person, and then the flow ends. The operation of the library apparatus may be temporarily stopped.

When it is determined that a phase shift occurs in an operation 705 (YES), the flow proceeds to an operation 706, where the phase shift is corrected. FIGS. 9A to 9E illustrate a correction operation performed when a phase shift between the timing belts 14 occurs, the base member 5 is inclined, and the movable belt-connecting portion 15M is located below the fixed belt-connecting portion 15F. FIGS. 9F to 9J illustrate a correction operation performed when a phase shift between the timing belts 14 occurs, the base member 5 is inclined, and the movable belt-connecting portion 15M is located above the fixed belt-connecting portion 15F.

A circle mark (◯) on the movable belt-connecting portion 15M in FIGS. 9A to 9E indicates that the movable belt-connecting portion 15M is not energized, and the base member 5 is coupled to the timing belt 14. A cross mark (×) on the movable belt-connecting portion 15M in FIGS. 9A to 9E indicates that the movable belt-connecting portion 15M is energized, and the base member 5 is not connected to the timing belt 14.

In an operation 801 in FIG. 8, it is determined which of the movable belt-connecting portion 15M and the fixed belt-connecting portion 15F is located above the other, based on the inclination of the base member 5 of the robot 4. FIG. 9A illustrates that the fixed belt-connecting portion 15F is located above the movable belt-connecting portion 15M. FIG. 9F illustrates that the movable belt-connecting portion 15M is located above the fixed belt-connecting portion 15F. In FIGS. 9A to 9J, the driving pulleys 11 that drive the timing belts 14 may be located above a bottom surface Y of the library apparatus.

In an operation 802 in FIG. 8, the driving pulleys 11 are rotated to lower the base member 5 until one of right and left ends of the base member 5 of the robot 4 comes into contact with the bottom surface Y of the library apparatus. For example, the driving pulleys 11 may be stopped by monitoring the pulses of an encoder provided on the motor. As illustrated in FIG. 9B, when the fixed belt-connecting portion 15F is located above the movable belt-connecting portion 15M, the end of the base member 5 provided with the movable belt-connecting portion 15M may come into contact with the bottom surface Y of the library apparatus first. As illustrated in FIG. 9G, when the movable belt-connecting portion 15M is located above the fixed belt-connecting portion 15F, the end of the base member 5 provided with the fixed belt-connecting portion 15F may come into contact with the bottom surface Y of the library apparatus first.

In the operation 802, when one of the right and left ends of the base member 5 comes into contact with the bottom surface Y of the library apparatus and the rotation of the driving pulleys 11 is stopped, in an operation 803, the movable belt-connecting portion 15M is energized to disconnect the movable belt-connecting portion 15M from the timing belt 14. FIGS. 9C and 9H illustrate a state in which the movable belt-connecting portion 15M is disconnected from the timing belt 14. The mark indicating the state of the movable belt-connecting portion 15M is changed from “◯”, which indicates a connected state, to “×”, which indicates a disconnected state.

In an operation 804, it is determined whether or not the movable belt-connecting portion 15M is located above the fixed belt-connecting portion 15F. When the movable belt-connecting portion 15M is located below the fixed belt-connecting portion 15F (NO), the flow proceeds to an operation 805. When the movable belt-connecting portion 15M is located above the fixed belt-connecting portion 15F (YES), the flow proceeds to an operation 806.

In the operation 805, as illustrated in FIG. 9D, the driving pulleys 11 are rotated to lower the base member 5 until the fixed belt-connecting portion 15F of the base member 5 comes into contact with the bottom surface Y of the library apparatus. Although the timing belts 14 on both sides of the base member 5 are move in a direction to lower the base member 5 owing to the rotation of the driving pulleys 11, because the base member 5 and the timing belt 14 are not coupled at the movable belt-connecting portion 15M, only the timing belt 14 moves. Thus, the end of the base member 5 provided with the fixed belt-connecting portion 15F also comes into contact with the bottom surface Y of the library apparatus.

In an operation 806, because the base member 5 is disconnected from the movable belt-connecting portion 15M, the base member 5 falls by gravity. Then, the movable belt-connecting portion 15M is lowered to the level of the bottom surface Y of the library apparatus. FIG. 9I may illustrate a state after the base member 5 falls by gravity.

Upon completion of the operation 805 or 806, the flow proceeds to an operation 807, where the movable belt-connecting portion 15M is deenergized, and the movable belt-connecting portion 15M is coupled to the timing belt 14. FIGS. 9E and 9J illustrate a state in which the movable belt-connecting portion 15M and the timing belt 14 are coupled. The mark indicating the state of the movable belt-connecting portion 15M is changed from “×”, which indicates a disconnected state, to “◯”, which indicates a connected state. Thus, processing in the operation 704 ends.

In an operation 707 in FIG. 7, similarly to the operation 704, the inclination of the base member 5 is measured, and the measured value is compared with the value when the base member 5 is not inclined. In an operation 708, it is determined whether or not the inclination of the base member 5 is corrected, based on the measurement in the operation 707. When the inclination of the base member 5 is corrected (YES), the processing returns to an operation 711, the operation of the library apparatus is restarted, and then the flow ends. When the inclination of the base member 5 is not corrected (NO), the flow proceeds to an operation 709, where it is determined whether or not the number of times the recovery processing is performed in the operation 706 is within a predetermined value.

When the number of times the recovery processing is performed in the operation 706 is within a predetermined value (YES), the processing returns to the operation 704, and a series of the operations from 704 to 709 is repeated. When the number of times the recovery processing is performed in the operation 706 exceeds a predetermined value (NO), the flow proceeds to an operation 710. In the operation 710, because the error due to the inclination of the base member 5 of the library apparatus is not corrected, a serious error may happen. Hence, in the operation 710, the error is reported to a management company to request recovery by a maintenance person, and then the flow ends. The operation of the library apparatus may be temporarily stopped.

An error occurring in the library apparatus is caused by a phase shift due to tooth-jumping between the timing belts 14 and the driving pulleys 11, the positional shift may be automatically corrected by the structure of the movable belt-connecting portion 15M. Because tooth-jumping does not occur during disconnection and re-connection at the movable belt-connecting portion 15M, no damage may be given to the timing belts 14.

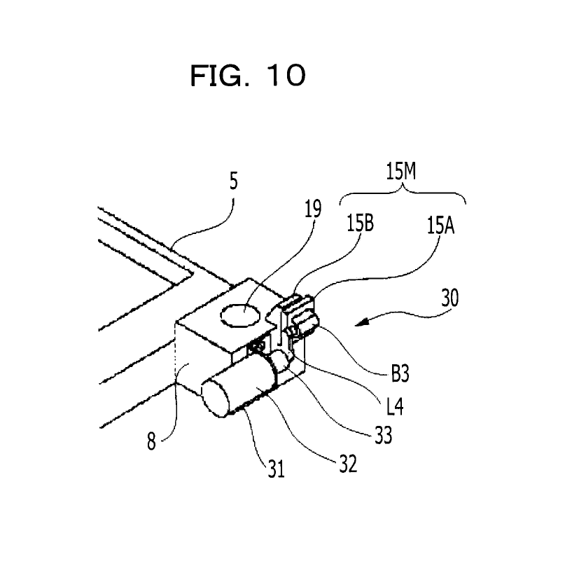

FIG. 10 illustrates an exemplary disconnecting mechanism. FIG. 10 illustrates a partial perspective view of the disconnecting mechanism 30 of the movable belt-connecting portion 15M, as viewed from the front of the library apparatus. In the disconnecting mechanism 30 illustrated in FIG. 10, components that are substantially the same as or similar to those of the above-described library apparatus will be denoted by the same reference numerals. The disconnecting mechanism 30 may be provided at an end of the guide block 8 having the guide hole 19, through which the guide post passes. A motor 32 is provided on the guide block 8 via the bracket 31, at a position adjacent to the movable belt-connecting portion 15M. A bracket B3 is provided on the engaging piece 15A of the movable belt-connecting portion 15M, and the lever L4 is provided on the bracket B3.

The lever L4 is directly coupled to a rotation shaft 33 of the motor 32. Thus, when the motor 32 is energized and rotated clockwise, the lever L4 is rotated and the engaging piece 15A of the movable belt-connecting portion 15M separates from the fixed portion 15B. A spring (not illustrated) that biases the engaging piece 15A toward the fixed portion 15B may be provided on the lever L4, so that the engaging piece 15A of the movable belt-connecting portion 15M is pressed against the fixed portion 15B when the motor 32 is deenergized.

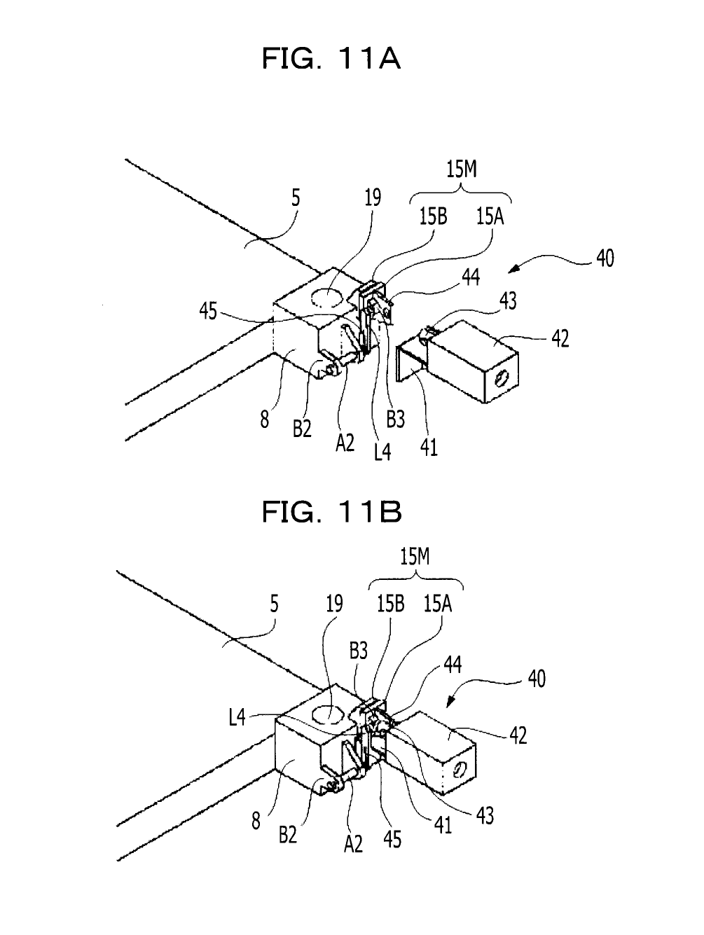

FIGS. 11A and 11B illustrate an exemplary disconnecting mechanism. FIG. 11A may illustrate an exploded perspective view of the disconnecting mechanism 40 of the movable belt-connecting portion 15M, as viewed from the front of the library apparatus. FIG. 11B is a perspective view illustrating a state in which a solenoid 42, which is also illustrated in FIG. 11A, is attached. In FIGS. 11A and 11B, components that are substantially the same as or similar to those of the above-described library apparatus will be denoted by the same reference numerals. The disconnecting mechanism 40 may be provided at an end of the guide block 8 having the guide hole 19, through which the guide post passes. The bracket B3 is provided on the engaging piece 15A of the movable belt-connecting portion 15M. The lever L4 is provided on the bracket B3, and the rotation shaft A2 provided at a base portion of the lever L4 is held by the bracket B2 in a rotatable manner. A spring 45 that presses a distal end of the lever L4 toward the engaging piece 15A is provided on the base portion of the lever L4.

In the disconnecting mechanism 40 illustrated in FIGS. 11A and 11B, the solenoid 42, from which a plunger 43 projects and into which the plunger 43 is retracted, may be attached to the guide block 8 or the base member 5 with a bracket 41. When the bracket 41 is attached to the guide block 8, a hole through which the timing belt passes may be provided in the bracket 41. A distal end of the plunger 43 is coupled to a connecting plate 44 provided above the bracket B3. By causing the plunger 43 to be retracted into the energized solenoid 42, the engaging piece 15A of the movable belt-connecting portion 15M is separated from the fixed portion 15B. When the solenoid 42 is deenergized, the engaging piece 15A of the movable belt-connecting portion 15M is pressed against the fixed portion 15B owing to an biasing force exerted by the spring 45, whereby the movable belt-connecting portion 15M is coupled to the timing belt 14.

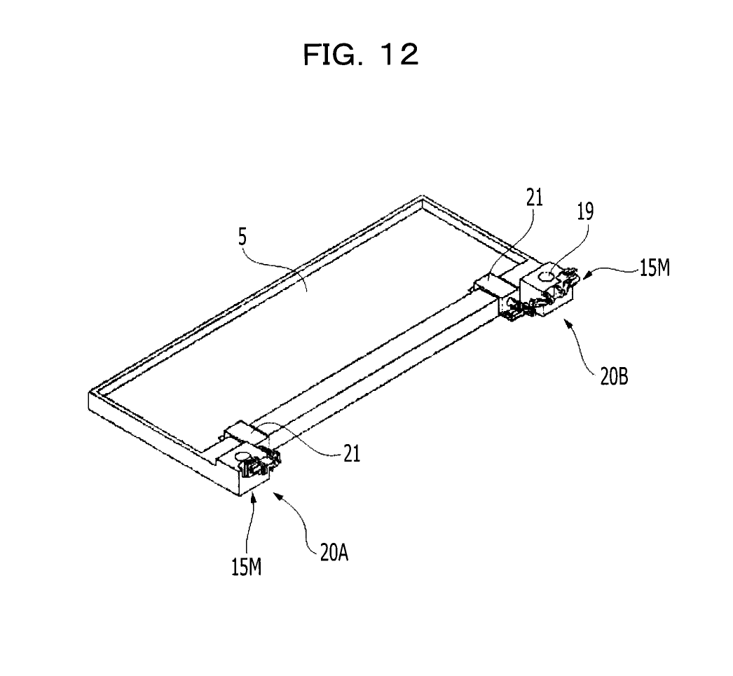

FIG. 12 illustrates an exemplary disconnecting mechanism. FIG. 12 may be a perspective view of the disconnecting mechanism 20 that disconnects the movable belt-connecting portions 15M from the timing belts 14, as viewed from the front of the library apparatus. The movable belt-connecting portions 15M are provided on both sides of the base member 5. The disconnecting mechanism 20 includes disconnecting mechanisms 20A and 20B that are attached to the movable belt-connecting portions 15M. The configuration of the disconnecting mechanism 20 may be substantially the same as or similar to that of the above-described disconnecting mechanisms. A phase shift occurring in either of the two timing belts is corrected.

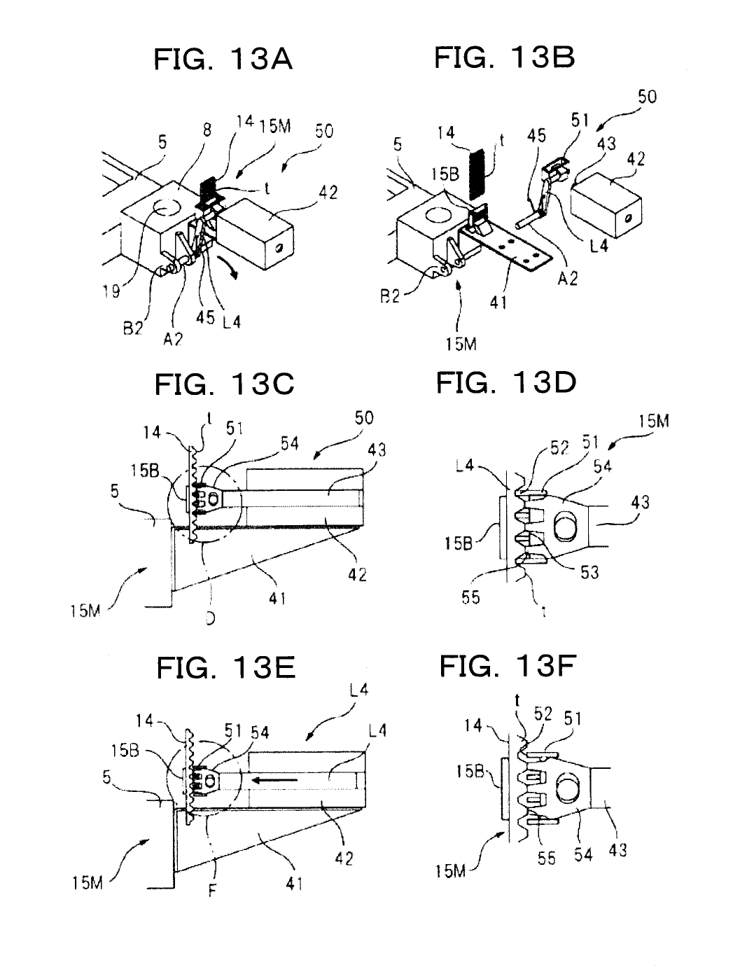

FIGS. 13A to 13F illustrate an exemplary disconnecting mechanism. FIG. 13A is a perspective view of the disconnecting mechanism 50 of the movable belt-connecting portions 15M, as viewed from the front of the library apparatus. FIG. 13B is an exploded perspective view of the disconnecting mechanism 50 of the movable belt-connecting portions 15M, illustrated in FIG. 13A. FIG. 13C is a side view illustrating a belt-connecting operation in the disconnecting mechanism 50 of the movable belt-connecting portions 15M, illustrated in FIG. 13A. FIG. 13D is an enlarged view of a part D in FIG. 13C. FIG. 13E is a side view illustrating a belt-disconnecting operation in the disconnecting mechanism 50 of the movable belt-connecting portions 15M, illustrated in FIG. 13C. FIG. 13F is an enlarged view of a part F in FIG. 13E.

The configuration of the disconnecting mechanism 50 of the movable belt-connecting portions 15M, illustrated in FIGS. 13A to 13F, may be different from that of the engaging piece 15A of the movable belt-connecting portions 15M illustrated in FIGS. 11A and 11B. In FIGS. 13A to 13F, the other configurations may be substantially the same as or similar to those illustrated in FIGS. 11A and 11B. In FIGS. 13A to 13F, the components that are substantially the same as or similar to those illustrated in FIGS. 11A and 11B are denoted by the same reference numerals. In FIGS. 11A and 11B, the engaging piece 15A of the movable belt-connecting portions 15M is pressed against or moved away from the fixed portion 15B by the movement of the solenoid 42 and the plunger 43.

In FIGS. 13A to FIG. 13F, an engaging frame 51 may be provided instead of the engaging piece 15A. The engaging frame 51 is biased against the fixed portion 15B by, for example, the lever L4 having substantially the same configuration as the lever illustrated in FIGS. 11A and 11B. Projections 52 that mesh with teeth t of the timing belt 14 is provided in the engaging frame 51, and Holes 53 are provided in recesses between the projections 52. A comb-like member 54 that projects from and is retracted into the holes 53 in the recesses is attached to the distal end of the plunger 43 that projects from and is retracted into the solenoid 42. The comb-like member 54 has projections 55. When the solenoid 42 is not energized, the projections 55 of the comb-like member 54 may be located at the bottoms of the holes 53.

In the disconnecting mechanism 50, when the plunger 43 is retracted into the deenergized solenoid 42, the projections 52 provided in the engaging frame 51 mesh with the teeth t of the timing belt 14, thus coupling the base member 5 and the timing belt 14. When the solenoid 42 is energized, the plunger 43 projects from the solenoid 42. As a result, the projections 55 of the comb-like member 54 provided at the distal end of the plunger 43 protrude from the holes 53, and, as illustrated in FIG. 13F, tips of the projections 55 are located at substantially the same positions as tips of the projections 52 provided in the engaging frame 51. Because the gaps between the tips of the projections 55 of the comb-like member 54 and the tips of the projections 52 provided in the engaging frame 51 is small, it may be difficult for the projections of the teeth of the timing belt 14 to enter the gaps.

Because the timing belt 14 is sandwiched between the fixed portion 15B of the movable belt-connecting portions 15M and the engaging frame 51 only by an biasing force exerted by the spring 45, when the timing belt 14 is driven by the driving pulley 11, the timing belt 14 may pass between the fixed portion 15B and the engaging frame 51.

The connecting portions between the base member 5 and the timing belts 14 are provided in a movable manner. Thus, even if tooth-jumping between the driving pulleys 11 and the timing belts 14 occurs, a phase shift between the timing belts 14 may be automatically reduced, without damaging the timing belts 14. At least one of the two connecting portions between the base member 5 and the timing belts 14 is movable and performs disconnection and re-connection of the connecting portion. Thus, the phase shift between the timing belts 14 is automatically reduced. When a phase-shift recovery operation is performed immediately after the library apparatus is turned on, a phase shift caused by an impact applied during transportation may be corrected before the library apparatus is operated, and hence, a highly reliable library apparatus may be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A library apparatus comprising:
a storage rack configured to be capable of storing a plurality of recording media;
a recording-and-reproducing device configured to perform a recording operation and a reproducing operation on the recording media;
a robot configured to deliver the recording media between the storage rack and the recording-and-reproducing device using a hand mechanism;
an elevator platform configured to carry the hand mechanism;
a pair of toothed belts, provided between a driving pulley and a driven pulley, configured to move the elevator platform vertically;
a pair of belt-connecting portions configured to couple one of ends of the elevator platform to one of the pair of toothed belts respectively; and
a disconnecting mechanism configured to release at least one of connections at the pair of belt connecting portions.

2. The library apparatus according to claim 1,
wherein each of the pair of belt-connecting portions includes a fixed portion provided on the elevator platform and an engaging piece that moves relative to the fixed portion.

3. The library apparatus according to claim 2,
wherein the engaging piece includes a teeth corresponding to a teeth of one of the pair of toothed belts.

4. The library apparatus according to claim 3,
wherein the disconnecting mechanism includes a bracket, provided on an opposite surface of the surface of the engaging piece on which the teeth is provided configured to hold a first rotation shaft in a rotatable manner;
a first lever whose distal end coupled to a projecting portion of the first rotation shaft from a second bracket; and
a rotation mechanism configured to rotate a second rotation shaft provided at a base portion of the first lever.

5. The library apparatus according to claim 4, wherein an elastic member that biases the first rotation shaft toward the engaging piece is provided in the first lever.

6. The library apparatus according to claim 5, wherein the rotation mechanism includes an electric motor that rotates about the second rotation shaft.

7. The library apparatus according to claim 5,
wherein the rotation mechanism includes:
a solenoid into which a plunger is retracted when the solenoid is energized; and
a linkage that couples the plunger and the second rotation shaft and rotates the second rotation shaft to rotate against an biasing force of the elastic member when the linkage is energized.

8. The library apparatus according to claim 3,
wherein the disconnecting mechanism includes:
a first bracket, provided on an opposite surface of the surface of the engaging piece having the teeth, configured to hold a first rotation shaft in a rotatable manner;
a first lever whose distal end is coupled to a portion of the first rotation shaft projecting from a second bracket;
a third bracket configured to hold a second rotation shaft provided at a base portion of the first lever; and
a reciprocating mechanism attached to a base member via an attachment member, configured to move when energized such that the opposite surface of the engaging piece is separated from the fixed portion.

9. The library apparatus according to claim 8,
wherein an elastic member that biases the first rotation shaft toward the engaging piece is attached to the first lever.

10. The library apparatus according to claim 3,
wherein the disconnecting mechanism includes:
a first bracket, provided on an opposite surface of a surface of the engaging piece with the teeth, configured to hold a first rotation shaft in a rotatable manner;
a first lever whose distal end is coupled to a portion projecting from the second bracket of the first rotation shaft;
a third bracket, provided at a base portion of the first lever, configured to hold a second rotation shaft;
an elastic member attached to the first lever so as to bias the first rotation shaft toward the engaging piece;
a reciprocating mechanism, attached to the elastic member, configured to push a working rod toward the engaging piece when energized; and
a comb-like member, including projections corresponding to holes provided in recesses formed in the teeth of the engaging piece and coupled to the working rod at a base portion, configured to move to positions of projections of the teeth provided on the engaging piece by movement of the working rod when energized.

11. The library apparatus according to claim 1,
wherein the disconnecting mechanism is provided on one of the pair of belt-connecting portions.

12. The library apparatus according to claim 1,
wherein the disconnecting mechanisms are provided on both of the pair of belt-connecting portions.
